(19) United States
(12) Patent Application Publication
(10) Pub. No.: US 2026/0143032 A1
(43) Pub. Date: May 21, 2026

(54) SYSTEM AND METHOD FOR SENSING AND MONITORING MARINE ENVIRONMENT

(71) Applicant: Marinelixirs Inc., Lafayette, CA (US)

(72) Inventors: Colin LANZL, Nashua, NH (US); Venkat Kabir BAHL, Lafayette, CA (US)

(21) Appl. No.: 19/393,843

(22) Filed: Nov. 19, 2025

Related U.S. Application Data
(60) Provisional application No. 63/722,138, filed on Nov. 19, 2024.

(51) Int. Cl. H04L 67/12; H04L 9/40; H04L 12/54; H04L 12/66; H04L 67/55

(52) U.S. Cl. CPC H04L 67/12; H04L 12/56; H04L 12/66; H04L 63/0428; H04L 67/55

(57) ABSTRACT

The present invention relates to a system (100) and method for sensing and monitoring marine environment. The system (100) comprises the primary components of a buoy (102), at least one gateway (104), at least one data concentrator (106), and a private cloud computing unit (108). Plurality of sensors (110-1, 110-2 . . . 110-n) are embedded with the buoy (102) for the acquisition of various physical, chemical and biological data of marine environmental conditions. The invention also relates to method of organizing such buoys (102) and directed towards providing a command, control and communicating through the gateway (104), and cloud computing unit (108) which is coupled with IoTs establishing an effective functioning between plurality of buoys working in conjunction with each other. The invention also relates to providing a method of measuring various parameters in the marine environment relating to seaweed cultivation through the buoy (102).

### FIELD OF INVENTION

The proposed invention relates to a system and method for sensing and monitoring marine environment and combining the monitored data with measurable metrics of the processed marine product to permit analysis and correlation, providing guidance to cultivation, processing, and management in a closed-loop system. More specifically, the present invention is directed towards a monitoring system installed in an on-water apparatus and a method thereof, that would provide a centralized platform for integrating data related to the marine environment and products therefrom. The invention may find its application in various fields where these data can be put to use.

### BACKGROUND OF THE INVENTION

The marine environment encompasses the world's oceans, seas, and coastal areas, comprising diverse range of ecosystems, species, physical and biological components. Progressively it is becoming more relevant and crucial to understand several marine environmental conditions, its complexity and interconnectedness for its sustainable uses of its resources. Marine environmental conditions encompass the physical, chemical, and biological aspects of the marine environment that influence the health and functioning of the marine ecosystems. These conditions include but are not limited to factors such as temperature, salinity, currents, tides, and nutrients availability.

Assessing these conditions is very important for marine farming technique known as aquaculture in which farms for marine life are placed offshore and/or in freshwater sources. Aquaculture includes seaweed cultivation that involves intentional growth and harvest of various types of macroalgae. It reduces the effects of oceanic eutrophication and acidification and oxygenates the seawater for a healthy ecosystem; and thus plays a significant role in global food security, environmental sustainability, and economic development. Success of seaweed farming is highly dependent on various marine environmental conditions including physical, chemical and biological factors that affect the growth, health and productivity of seaweed. Thus, it is necessary to sense and monitor these marine environmental conditions in managing seaweed farming operations and ensuring sustainable production.

There are several factors or conditions affecting the growth and productivity of seaweed farming including but not limited to adequate sunlight, optimal depth ranges of water, seasonal and diurnal sunlight intensity, water turbidity caused by suspended particles, optimal temperature ranges, current and waves of the water. Additionally, the presence of micronutrients in water, tidal influence, cyclonic storms, wave height, salinity fluctuations of water, adequate dissolved oxygen levels, pH levels of water, absorbed CO₂ levels, growth of other contaminant organisms on the surface of seaweed are also some of the important marine environmental conditions that requires real-time monitoring for the cultivation of macroalgae such as seaweed.

However, in the conventional technology there exists no monitoring system that would provide a centralized platform for integrating data collected from various sensing apparatuses for the above discussed marine environmental conditions affecting the growth and productivity of seaweed farming. There is no platform where various sensing apparatus may be installed with internet of things (IoT) connectivity for storing, processing and analyzing. There is a requirement for an advanced system that would enable a user towards sensing and remote monitoring, real-time alerts, and data-driven decision-making. There is a further requirement to acquire data related to marine environmental conditions over a very wide seaweed farm, map and analyze with the spatial data related to seaweed farming sites.

In addition to the lack of centralized monitoring system, there are very few marine growth systems for seaweed that employ a co-located multiplicity of sensors that can be used to simultaneously acquire seawater conditions that impact seaweed growth. Currently, gathering sea conditions for seaweed growth require seawater samples to be gathered at the seaweed growing site and processed later in a laboratory, with the data tabulated and available well after the actual sampling time. Additionally, there is a general lack of timely information availability based on the analysis of that data.

As an example, common water sampling methods use multiple instruments (see USA State of Wisconsin Department of Natural Resources Standard Operating Procedures “Temperature, Dissolved Oxygen, Conductivity and pH Depth Profile Monitoring Procedure on Lakes”, Lake Monitoring Protocol EGAD #3200-2021-10), but the data is recorded by hand and possibly later uploaded to some standard database. This type of collection of water profile data is fine for long-term, infrequent monitoring of aquatic conditions but unsuitable for monitoring daily conditions of seaweed growth when the growth cycle is something like 30-60 days. It is especially unsuited to reacting to immediate changes in the environment, such as chemical spills from industrial releases or events such as algae blooms.

Thus, as the field of seaweed farming continues to grow, presently there is a dire need for an improved technology and adaptation of continuous monitoring systems that play a crucial role to measure, analyze and manage various physical, chemical and biological parameters and thereby supporting sustainable and efficient cultivation leading to development of the industry.

The Chinese patent document CN111776140A discloses a marine ecology automatic monitoring buoy system where a data acquisition module is mainly used for recording data values detected by the meteorological detection module and the water quality detection module and further transmitting the recorded data values to the wireless transmission module. This document further teaches regarding water quality detection module comprises a pH sensor for detecting an underwater pH value, an ORP sensor for detecting an underwater ORP value, a dissolved oxygen sensor for detecting an underwater dissolved oxygen value, a turbidity sensor for detecting underwater turbidity, a conductivity sensor for detecting underwater conductivity.

The Korean patent document KR2022-0085235A discloses a marine water pollution level measuring and monitoring system, comprising performing water pollution level measurement in a state in which a control module, a GPS module, and a wireless communication module are composed of one unit module and mounted on a buoy floating on the sea or mounted on a drone. This document directs a person to devise a sensor module configured to measure seaweed contamination level including a turbidity sensor, a pH sensor, a temperature sensor, a dissolved oxygen saturation sensor, and a salt measurement sensor, a camera module configured to photograph an area requiring measurement of seaweed contamination level. Further, the Korean document teaches a control module which is configured to receive data sensed from the sensor module and transmit the data to a central control server through arithmetic processing, a marine water pollution level measuring unit including a GPS module for generating location information measured by the sensor module, and a wireless communication module for transmitting and receiving sensed data and the location information from the sensor module. A control unit in the patent document is configured for collecting the sensed data and the sensing location information by the marine water pollution level measuring unit. A central control server described in KR2022-0085235A is configured to transmit sensing data and location information to the smart device; and a smart device configured to receive and output a measurement value of water quality contamination and measurement location information from the central control server, wherein the marine water quality contamination level measurement unit includes a sensor module, a camera module.

With a view therefore to address the requirement in the existing technologies in the field of monitoring marine environment, the inventors devised a novel system and method for sensing and monitoring marine environment. The present invention proposes to provide a monitoring system that would provide a centralized platform for integrating data from various sensing apparatuses that would enable a user towards remote monitoring, real-time alerts, and data-driven decision-making.

The present invention provides a comprehensive platform that combines various technologies with a holistic approach towards timely data collecting, processing, and analyzing from various sources, offering a unified approach to optimizing aqua life farming operations and managing the complex variables affecting seaweed cultivation.

### OBJECT OF THE INVENTION

It is a primary object of the invention to measure, analyze and manage in real time various physical, chemical, and biological parameters in marine environment and products therefrom; and thereby provide valuable data and insights enabling users to optimize growing conditions and processing to increase yields, maximize product efficacy and minimize environmental impacts on aquaculture including sustainable seaweed cultivation.

### SUMMARY OF THE INVENTION

The present invention proposes to provide a system for sensing, monitoring and responding to the marine environment. The invented system is implemented through a platform housing plurality of sensing apparatuses for the acquisition of data concerning marine environmental conditions related to seaweed aquaculture and dissemination of that data from a very wide area of seaweed farms to permit the analysis of the data along with recommendations for optimization of the resulting marine products. Without any intended limitation, the physical platform may also be termed as buoy platform.

According to an embodiment, the present invention also provides a method of measuring various parameters in the marine environment relating to seaweed cultivation through the buoy platform.

According to an object of the invention, the sensor apparatuses for collecting and transmitting data include, but are not limited to, a combination of sensors to collect data related to temperature, pH, salinity, conductivity, dissolved oxygen, turbidity, underwater flow velocity and direction at a predetermined depth or depths. The sensor apparatuses further comprise plurality of sensors to collect data related to surface conditions such as barometric pressure, surface airflow velocity and direction, wave action, and chemical pollutants such as, but not limited to, nitrates, nitrites, phosphates, ammonia. The data collection and delivery of data from these sensor apparatuses is configured to be executed at either predetermined or adjustable times. The system is further provided with automated elements for the real-time secure collection and delivery of data from these sensor apparatuses.

According to one object of the invention, the physical platform is manufactured in a water-tight or water-proof manner that houses various sensing apparatus for collecting marine environmental factors. The buoy may be constructed from plastic materials, with prototypes 3D printed using PLA, ABS, or PETG. Alternatively, the buoy may be constructed with any technology that provides low-cost, waterproof housing for the sensors and electronics such as, but not limited to, injection moulding of plastic materials or other substances. Water-tight integrity is achieved through thread-sealants, washers with nuts or locknuts, or other conventional sealing mechanisms to prevent water ingress into the electronics of the buoy. The physical platform is provided with independent power supply and energy management mechanisms. According to one preferred embodiment, the energy management mechanisms comprise implementation of solar powered, wave powered and/or re-usable or disposable batteries whose state of charge can be measured.

Further, optionally, the platform is provided with buoyancy control mechanisms for operating the platform. To ensure real-time position monitoring, a GPS subsystem operating with GPS, GLONASS, BeiDou, Galileo, IRNSS or other satellite navigation systems that supports sub-meter accuracy may also be embedded in the platform. Furthermore, the GPS acquisition parameters may be updated via commands issued through whatever IoT link is used to communicate with the marine buoy.

According to one embodiment of the invention, the platform may be either fixed or tethered to seaweed growing platforms. Such growing platforms include monolines or rafts or other cultivation platforms.

According to one object of the invention, the sensor platform is provided with biocide and sensor apparatuses for algal or other contaminant growth control. Furthermore, the underwater surfaces of the buoy may be coated with a biocide such as cuprous oxide that both inhibits algal and biological contamination without interfering with seaweed growth.

The present invention also ensures the cryptographic confidentiality and security of the processing, transmittal and analysis of environmental condition data. To that effect, the platform in provided with has self-destruction or self-erase mechanism or firmware.

According to another object of the invention the invented system is provided with at least one processor unit for post processing of data coupled with a preferred mechanism of securely transporting the data to a data concentrator or gateway connected to a secure cloud data storage platform.

The present invention further proposes a method of organizing such platforms implementing the invented system for sensing and monitoring marine environment. The method is directed towards providing command, control and communications through a data network which is coupled with standard IoT protocols establishing an effective functioning between plurality of buoy platforms working in conjunction with each other.

According to the preferred embodiment, the invented method comprises the steps of:
securely configuring and programming a network of single or multiple platforms to exchange various communication signals by means of the processor unit;
collecting signal emissions related to the data from subset of one or more platforms of particular sea or marine parameters by means of the processor unit;
securely delivering said data to a cloud computing unit;
securely delivering, configuring and thereupon installing the initial operational firmware for each by means of the processor unit; and
securely updating, validating and installing new versions of the operational firmware for each platform as needed, including all security elements and parameters.

According to one embodiment of the invention, the various communication signals are exchanged within the coverage area pertaining to the farming of seaweed. The data collected from the signals of the sensor apparatuses, without any limitations is implemented for the purpose of checking and influencing seaweed growth and relevant environmental conditions. Further, the invented method comprises the optional step of locally analyzing and reducing said data based on specific requirements of each of the sites of the buoy platform.

According to one embodiment of the invention, the term “seaweed” is understood to mean macroscopic, multicellular marine algae, which may be wild or cultivated. Wild seaweed typically grows in the sea or in the ocean at the water bottom without the need for human cultivation or care. The farmed seaweed is typically planted on various supports such as rafts, ropes, fabrics, nets, pipe networks, etc., which are typically placed under the surface of the sea or ocean. Seaweed may also be cultivated in a pond, pool, tank or reactor containing seawater and placed on shore or inland. The term “seaweed” includes members of red (Rhodophyta) seaweed, brown (Phaeophyta) seaweed and green (Chlorophyta) seaweed as well as others.

More preferably, the seaweed is red seaweed selected from the group consisting of Cunninghamiaceae (Gigartinaceae), Caesalpiniaceae (Bangiophyceae), Palladiaceae (Palmariaceae), Sha (aike (Hypneaceae), Alternidae (Cystocloniaceae), Solieriaceae (Solieriaceae), Phyllodaceae (Phyllophoraceae) And Fusaraceae (Furcellariaceae) Or combinations thereof. Most Preferably, the seaweed is selected from the group consisting of Red Cabbage Genus (Bangiales), Carrageenan Genus (Chondrus), Ginkgo Genus (Iridaea), Palmaria Genus (Palmaria), Sequoyis Genus (Gigartina), Gracilaria Genus (Gracilaria), Agar Genus (Gelidium), Red Tongue Genus (Rhodoglossum), Sargassum Genus (Hypnea), Eucheuma Genus (Eucheuma), Kappaphycus Genus (Kappaphycus), Agarchiella, Cladophora Genus (Gymnogongrus), Sarcothalia, Phyllophyllum Genus (Phyllophora), Isodon Genus (Ahnfeltia), Eupatorium Genus (Mazzaella), Europhyllum Genus (Mastocarpus), Soft Thorn Genus (Chondracanthus), Sarcandra Genus (Furcellaria), and mixtures thereof.

Kappaphycus seaweed has temperature and sunlight requirements for optimal growth. When the sunlight intensity and duration is too high and too long, coupled with seawater temperatures reaching beyond 28 degrees Celsius, a condition known as ice-ice develops in the seaweed, turning it a white color. This is a lagging indication of severe damage to the seaweed. One function of the invention is for the sensor platform to monitor both the solar illumination and the surface seawater temperature and the subsurface seawater temperature at depths below the surface. A feature of the invention is for the sensor platform to automatically determine when the sea conditions of temperature and solar illumination trend toward the conditions that result in ice-ice, that the platform alters the buoyancy of the raft to sink the raft to a subsurface level where the seawater temperature and solar illumination are optimal for seaweed growth. The raft buoyancy can be altered in a crude manner by simply informing the farmers to add weights to the raft or in a more sophisticated manner by autonomously changing buoyancy mechanisms similar to those used by SCUBA divers to maintain the raft at the optimum temperature/illumination subsurface level when sea surface conditions are poor. The autonomous process of changing buoyancy may be based on monitoring the surface and subsurface conditions (e.g. temperature) on a raft with autonomously adjustable buoyancy. The system commands the buoyancy mechanism to lower/rise the raft somewhat in search of more favorable growth conditions. The system can then monitor the new conditions and iterate the procedure until the conditions at the level of the seaweed is found to be in good growth conditions and less prone to ice-ice conditions.

There are other conditions that are inimical to desired seaweed growth. Certain kinds of small fish and turtles that eat seaweed arrive at certain times during the growing season. These fish consume all the growing seaweed before it is mature. Common methods of dealing with this problem are to arrange fine-mesh nets on the rafts below the growing seaweed. These nets are not always successful at keeping the fish away because some are small enough to fit within the meshes of the nets and some fish simply bite through the nets to make holes big enough to get to the growing seaweed. It has been observed that there is a seaweed that these fish do not eat during their season. By processing this seaweed in a manner similar to the desired seaweed (pulverizing and extracting the liquid from the pulverized mass), the liquid can be used to pre-treat by soaking the desired seaweed seeds in this new liquid. The fish that eat the desired seaweed do not eat the pre-treated desired seaweed during the season that the seaweed-eating fish are present.

Alternatively, one or more sensors can be used to detect markers left by the presence of predatory fish or turtle. Optionally, visual camera data may be used to indicate the presence of predatory fish. Further, the invented system may be configured to release chemicals into the water that annoy or damage the fish or turtle so that they do not come near the seaweed.

Another method of preventing fish from marauding the desired seaweed is to have the sensor platform establish a sound-field around the growing raft (for example, using hydrophones) and to detect fish incursions within the sound field and autonomously release the processed sap from the seaweed that the fish don't like into the water around the raft to keep the fish away. Both of these described methods of discouraging fish from eating the cultivated seaweed can be used singly or jointly.

Thus, the invented system and method permit the analysis of the data, reducing it to actionable recommendations that can be delivered to users, including but not limited to the managers of the cultivation farms, and the farmers themselves.

The on-water platform combines a processor unit coupled with sensors, electronic subsystems for converting sensor data to digital form and electronic radio subsystems for the secure delivery of the real-time sensor data from the sensors co-located with the growing seaweed, to data concentrators. These data concentrators gather inputs from multiple individual sensor platforms and deliver the data to gateways which have connections using some standard transport mechanism to a private cloud computing unit on the Internet. The transport mechanism includes but is not limited to such as wired Ethernet, wireless sensor networking protocols, proprietary mesh transport layers or cellular backhaul or satellite backhaul. The data concentrator and the gateway may be combined into one physical unit. The data concentrator or gateway may perform further analytical, aggregation and security actions on the data before preparing the data to be published to appropriate cloud subscriber module.

The modules in cloud computing unit deliver analyzed data to secure data storage and archival functions as well as serving as publishers of analyses of the secure data in formats that provide actionable recommendations for subscribers, depending on their needs and subscriptions, anywhere in the world. Several proprietary algorithms, predictive AI and/or generative AI can be implemented to achieve an efficient real-time analysis of the data collected from the plurality of buoy platforms working in conjunction with each other.

The invented system and method for monitoring marine environment can be utilized for monitoring seaweed cultivation by measuring various sea conditions and actuate growing apparatus such as, but not limited to, those designed to optimize growth of seaweed. The invented system and method can be also utilized for monitoring and securely delivering to the cloud computing unit similar data for aquaculture, fisheries, climate or other such aquatic applications. The present invention also finds its utility in monitoring freshwater or sea/marine state, weather conditions, detecting cyclonic storms, marine contamination and/or other environmental conditions and securely delivering that data to a secure cloud computing unit and securely delivering cogent, actionable analyses to subscribers.

### BRIEF DESCRIPTION OF THE DRAWINGS

The proposed invention is illustrated in the accompanying drawings, throughout which like reference letters indicate corresponding part in the various figures. The embodiments herein will be better understood from the following description with reference to the drawings, in which:

FIG. 1 is a schematic block diagram of the integral components of invented system for sensing and monitoring the marine environment according to one preferred embodiment of the invention.

FIG. 2 illustrates a flow chart diagram depicting the steps related to data acquisition from the buoy and its transmission performed in the invented system according to one object of the invention.

FIG. 3 illustrates a flow chart diagram depicting the steps performed by the invented system in the data concentrator according to one object of the invention.

FIG. 4 illustrates a flow chart diagram depicting the steps performed by the invented system in the private gateway according to one object of the invention.

FIG. 5 illustrates a flow chart diagram depicting the steps performed by the invented system in the cloud computing unit according to one object of the invention.

### DETAILED DESCRIPTION OF THE DRAWINGS

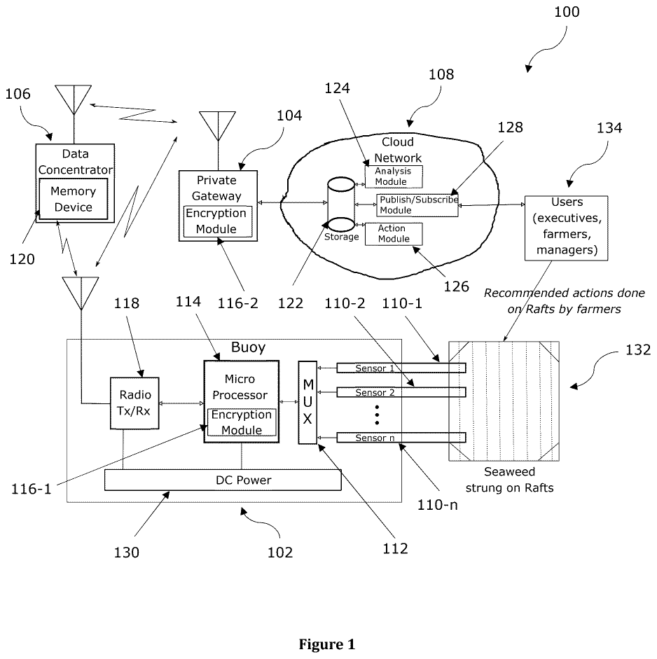

FIG. 1 of the accompanying drawings illustrates a schematic block diagram of the integral components of invented system (100) for sensing and monitoring the marine environment. The invented system (100) has a closed-loop operation, designed to optimize the growth cycle of the organic material being farmed. The preferred embodiment of the invention is designed to optimize the growth of seaweed (132). However, the system (100) is not limited to seaweed, as it can be also used to optimize the growth of other organic, water-grown species (132) such as fish. This closed-loop system (100) may be highly automated, but ultimately is controlled by people in the loop, as described herein below.

As shown in FIG. 1, the primary components of the invented system (100) comprises a buoy (102), at least one gateway (104), at least one data concentrator (106), and a private cloud computing unit (108). The system (100) can also comprise a plurality of buoys (102) which are on-water buoys (102). These on-water buoys (102) are the core of the system (100) that primarily comprises plurality of sensors (110-1, 110-2 . . . 110-n) and a communication unit (118). The communication unit (118), without any limitation, can be a radio-communication link as depicted in the preferred embodiment.

The buoy (102) forms the primary on-water platform in the system. In an exemplary embodiment of the invention, the buoy (102) is constructed from plastic materials, with current prototypes 3D printed using PLA, ABS, or PETG. Alternatively, the buoy (102) may be manufactured using injection molding, potentially using different plastic types for mass production. The dimensions of the buoy (102) are designed to ensure water-tight integrity, achieved through means such as thread-sealants, washers with nuts or locknuts, or other conventional sealing mechanisms. These measures prevent water ingress, ensuring the electronics on the buoy (102) remain dry and functional. To prevent algal and biological contamination, the underwater surfaces of the buoy are coated with cuprous oxide marine hull paint, effectively inhibiting growth on exposed surfaces.

The plurality of sensors (110-1, 110-2 . . . 110-n) are tailored to the types of species (132) being farmed. More specifically, the said sensors (110-1, 110-2 . . . 110-n) are tailored to the needs of the species (132) being grown. In the preferred embodiment of the invention, the central location is a private cloud computing unit (108). The radio-communications link (118) are configured to deliver the data sensed by each of said sensors (110-1, 110-2 . . . 110-n) to the central location (108). The most important function of the sensors (110-1, 110-2 . . . 110-n) of on-water buoys (102) is thus measuring the sea parameters critical to the optimal growth of the species (132) under cultivation by means of said plurality of sensors (110-1, 110-2 . . . 110-n).

In an exemplary embodiment, the invented system (100) is configured to monitor and analyze seaweed cultivation. In an exemplary embodiment, the buoy (102) houses multiple sensors (110-1, 110-2 . . . 110-n) within water-tight sensor tubes, with active sensor components positioned approximately 18 cm below the top surface buoy (102), situating them close to the seaweed being cultivated. The sensor tubes have externally threaded ends that engage internally threaded mounting locations on the housing of the buoy (102), allowing easy installation and replacement while maintaining watertightness. Here the plurality of sensors (110-1, 110-2 . . . 110-n) are configured to collect data involving parameters such as temperature, pH, dissolved oxygen, seawater conductivity, seawater turbidity, and solar illumination that are key parameters needed to optimize growth. These parameters are non-limiting in their nature and more parameters may also be important contributors. In another example, the sensors can be configured to detect industrial contaminations in the sea water that affect the growth of the marine species (132). More detailed specific exemplary embodiments are described herein below.

As seen in FIG. 1, the invented system (100) employs a multiplicity of sensors (110-1, 110-2 . . . 110-n), which are operationally coupled with a multiplexer (MUX) (112). The multiplexer (112) is configured to receive the data sensed by each of said sensors (110-1, 110-2 . . . 110-n). The multiplicity of sensors are tailored to the species being cultivated. Standard sensor arrays include pH, dissolved oxygen, temperature (surface and at various depths), conductivity, turbidity, and solar illumination. The sensors (110-1, 110-2 . . . 110-n) typically operate with sampling intervals adjustable by firmware, currently around 50 milliseconds per sensor.

The sensors (110-1, 110-2 . . . 110-n) are housed in modular sensor tubes designed for easy exchange and replacement. Each sensor tube interfaces with the housing of the buoy (102) via threaded connections sealed for water-tight installation. The modularity of the sensors (110-1, 110-2 . . . 110-n) allows repurposing buoys for specific functions such as discovery buoys targeting certain chemical pollutants (nitrates, phosphates, ammonia) or growth buoys focusing on conditions directly impacting cultivation.

Although sensors for chemical pollutants including nitrates, nitrites, ammonia and ion-specific electrodes are available and can be mounted in sensor tubes, such expansion should be anticipated to include these specialized sensors as needed and economically feasible.

The multiplexer (112) in turn is controlled by a processor unit (114) embedded in the buoy (102). The measurement data for each sensor is stored in the memory of processor unit (114) until a complete sensor profile has been obtained. This sensor profile is formed into a single data transmission packet by the processor unit (114). Thus, the processor unit (114) controls said multiplexer (112) and thereby formulates a single data transmission packet from corresponding sensor profile. According to an exemplary embodiment of the invention, the processor unit is the STmicro STM32WL55JC1, a low-power microcontroller with sufficient processing power and memory capacity for sensor data acquisition, processing, and communication. Additional memory may be integrated for extended data storage or enhanced edge computing capabilities.

Further, the processor unit (114) comprises an encryption module (116-1) to encrypt said data transmission packet prior to delivering sensor information to the gateway (104) though the radio communication unit (118). According to exemplary embodiment of the invention, the processor unit (114) incorporates AES encryption protocols, specifically AES-128 and AES-256, securing data prior to wireless transmission. Encryption ensures data confidentiality and integrity throughout transmission and in storage within the cloud system. Standard Ethernet WAN protocols and encryption keys are used for communication with the private cloud entity. The buoy encrypts data messages using standard AES-256 encryption BEFORE the normal LoRa encryption (which uses AES-128) as an additional security measure. When the buoy message reaches the gateway, the gateway only needs to do the standard LoRa AES-128 decryption before sending the AES-256-encrypted data to the private cloud.

Alternatively, the processor unit (114) can be replaced with a subsystem which is configured to arrange the data in a serial format to be sent over the network of data concentrators (106) and/or gateway (104). In an exemplary embodiment, the processor unit (114) may be fitted with an analog-to-digital subsystem that has multiple channels that can each be connected to a sensor and sampled in parallel. The data transmission packet undergoes local encryption by means of the encryption module (116-1) and is subsequently sent over a private radio link. Each buoy (102) is provided with DC power source (130) connected with said communication unit (118) and the processor unit (114) to power-up the same. According to an exemplary embodiment, the buoy is powered by batteries as the power source (130). Preferred implementations use three alkaline D-cell batteries in series, each with a capacity of at least 10,000 mAh, which have demonstrated multi-year service life given the data transmission frequency of up to four transmissions per day. Alternative battery technologies such as lithium-ion may be used, provided the voltage ranges between 1.0 and 5.0 volts with a minimum capacity of 7,000 mAh. Maintenance involving battery replacement and cleaning of biological accumulation on the buoy (102) occurs in synchronization with seaweed harvest cycles, typically every 45-60 days.

Alternatively, solar panels and wave-powered generation can complement or substitute battery power as power source (130) in future iterations of invented system (100). Battery status is actively monitored and conveyed through the system, optimizing maintenance scheduling and ensuring uninterrupted buoy operation. The system (100) actively monitors battery state to inform operational teams of maintenance needs.

The radio-communications links are formed and monitored by one or more gateways (104). The gateway (104) as shown in FIG. 1, is configured to form or set up said radio communication links. The gateway (104) then monitors and maintains said radio communication links. Furthermore, the gateway (104) collects data transmission packets from said buoy (102) to forward the same to said cloud computing unit (108). Thus, the gateways (104) establish a communication link between said data concentrator (106) and said cloud computing unit (108). The buoy (102) communicates sensor data wirelessly using a secure radio link based on the LoRaWAN protocol. The communication link supports bidirectional encrypted data transmission to gateways or data concentrators residing within range.

In certain cases, the on-water buoys (102) may not be within communications range of any gateway (104). For such scenarios, local data concentrators (106) perform the function of a store-and-forward mechanism to forward the data communications packets. Thus, the data concentrator (106) in the invented system (100) acts like a pseudo-gateway to establish communication links between co-located buoys within communication range and the actual or true gateway. In another preferred embodiment the data concentrator (106) is configured to perform in a multi-hop scheme, or a mesh scheme, to other similar data concentrators (106) that are within range of a gateway (104). In the mesh scheme, a network topology is developed in which each of said data concentrators connects directly with multiple neighboring data concentrators. This scheme creates a web-like structure, where the data can be transmitted to the central location using any combination of data concentrators (106) and corresponding buoys (102), and thus creating multiple paths for data transmission. These paths of transmission in the mesh scheme are configured to create a bi-directional communication between similar data concentrators (106) that are within range of a gateway (104). Advantageously, in a situation, where a particular buoy (102) or data concentrator (106) is non-functional, the mesh scheme allows the data to find an alternative path using functional buoy or data concentrator (106) within its range. This allows the system (100) to adapt dynamically to changing marine conditions, making them ideal for an adverse environment.

In other words, the data concentrator (106) is basically a version of the gateway (104) with no connection to the cloud. However, the data concentrator (106) comprises memory devices (120) to store said data transmission packet received from said on-water buoy (102). Thus, the data concentrator (106) has significantly greater memory and whose purpose is to act like a pseudo-gateway. In a scenario, where said system (100) comprising plurality of data concentrators (106), a network of data concentrators (106) thus is formed to communicate between themselves to forward data packets on to an actual gateway (104) connected to said cloud computing unit (108).

The data concentrator (106) may use satellite communications networks to fulfill their gateway function. In a cost-effective solution, these data concentrators (106) may store multiple messages from multiple buoys before bundling them up into a single, lower-cost message to be sent to the private cloud via a satellite link.

Data concentrators (106) are controlled by one gateway (104) that can communicate with both the network of data concentrators (106) and the cloud computing unit (108). The network of data concentrators (106) thus simply performs the function of forwarding data information collected by the sensors installed on the on-water buoys (102) that are not within range of an actual gateway (104). Similar to gateways (104), data concentrators (106) can forward packets both outbound toward a true or actual gateway and inward from a gateway (104) to the on-water buoys (102) that it serves.

The data concentrators (106) are to be understood as a “Store-and-Forward Mesh Gateway” which is distinguished from the LoRaWAN protocol's usage of “data concentrator”. The Store-and-Forward Mesh Gateway has all capabilities of a standard gateway but is not directly connected to a network capable of transferring data to a private cloud. Instead, it stores time-stamped data for later transmission to a true gateway when one is discovered and incorporated into the mesh network.

When data packets are not being exchanged between the data concentrator (106) and buoys, it sends out proprietary messages to other such data concentrator within communication range. These messages function like normal routing messages in an Ethernet network, asking other entities if they have information concerning routing links to a cloud-connected network. As such devices get route inquiry messages from other such devices, they construct tables of source and destination addresses permitting them to respond to inquiries with either “destination unknown now” or “destination known and forwarding initiated” responses. These data concentrators (106) are differentiated from standard Gateways by having significantly more memory for the storage of messages to be forwarded and for the necessary meshed routing tables.

A secondary function of a data concentrator (106) is to respond to any local on-water buoys (102) in its service area when a buoy (102) has been subjected to unauthorized or tampering activities. These activities include scenarios wherein the buoy (102) has been removed or an attempt has been made to disassemble or move the buoy (102) from its designated location. In such scenarios, the data concentrator (106) can direct any buoy (102) that has been tampered with to immediately erase all data and operating firmware. The data concentrator (106) can optionally direct a buoy (102) to self-destruct, considering such technology and hardware option is available to that buoy (102). The buoy (102) is provided with a separate processor to securely download firmware updates after passing a handshake mechanism. In an embodiment where the buoy (102) is provided with such security measures, a limit switch is provided inside the buoy (102). Once the limit switch is triggered, the separate processor communicates the same to the gateway (104) or data concentrators (106) and receives the appropriate commands in case of tampering. This is a theft and tamper resistance feature of the system (100).

As depicted in FIG. 1, the gateway (104) comprises an encryption module (116-2) to cryptographically encrypt, and/or decrypt said data transmission packet. The gateway (104) thus establishes and maintains a bidirectional, cryptographically encrypted communications link with each buoy (102). In cases, where the on-water buoys (102) may not be within communications range of the gateway (104), the bidirectional communication may be maintained with any data concentrators (106) in its network. In addition, the gateway (104) can decrypt and re-encrypt the sensor data packet to be sent to the cloud computing unit (108), to meet the privacy requirements of the users (134) and other consumers of that data.

The primary function of the gateway (104) is to send the encrypted sensor data packet to the secure private cloud computing unit (108). The connection between the gateway (104) and the cloud computing unit (108) can be made using standard wired network protocols like Ethernet. Further communication means may include but are not limited to a part of a public switched network such as a mobile telephone network, or as part of a satellite network. An important secondary function of the gateway (104) is to relay on-water sensor buoy firmware back to the buoys (102) and also to any data concentrators (106) within that gateway's network. Another secondary function is to respond to tamper incidents in the same manner as data concentrators (106).

The modules (124, 126, 128) in the cloud computing unit (108) handle the functions of storage of the incoming data from the gateways (104), the analysis of data from each of a multiplicity of farms, the generation of actionable recommendations based upon analysis and the entire mechanism of publishing recommendations and information to subscribers. Subscribers to the modules in the cloud computing unit (108) may receive actionable recommendations tailored to the geographic area of each farm or to each zone within a large farm or to a defined subset of geographically located farms. Subscribed users (134) can receive the data in the form of automated telephone calls or text messages or email messages and alerts to ensure timely delivery. Subscribers may also query the system using proprietary algorithms such as generative AI, in order to understand current ocean conditions, and get recommendations on actions to optimize growth of seaweed or aquatic farms. A similar set of queries can be used for climate models.

The cloud computing unit (108) is operationally connected with said gateway (104) to receive said data transmission packets from said gateway (104) and, after analysis and recommendation generation by the elements in the private cloud computing unit (108), thereby establish interactions between a user (134) and one or more buoys (102) associated with growing seaweed in a farm. The cloud computing unit (108), as shown in FIG. 1 comprises a storage device (122), an analysis module (124), an action module (126), and a subscription module (128). The storage device (122) is configured to maintain said data transmission packet from said buoy (102) along with additional data as per the requirements for the application of the invented system (100). The additional data stored in the storage device (122) may include predefined sea parameters critical to the optimal growth of the species (132) under cultivation. The data stored in the storage device (122) may also include predefined sea parameters causing specific diseases in the species (132) under cultivation.

The analysis module (124) is configured to analyze said data transmission packet drawn from said storage device (122). The action module (126) is configured to process said analysis of said analysis module (124) and thereupon generate actionable recommendation. The subscription module (128) is configured to receive the actionable recommendation from said action module (126), authorize a user (134) to access said cloud computing unit (108), and thereupon receive published actionable recommendation sent to the user (134). For example, in case where storage device (122) contains predefined sea parameters causing specific diseases in the species (132) under cultivation, the analysis module (124) analyses said data transmission packet from said buoy (102) vis-à-vis said predefined sea parameters, flagging a potential problem. After that, the action module (126) processes said problem analysis to provide actionable recommendation to the user (134) transmitted via the subscription module (128) to mitigate said specific diseases.

The storage device (122) is vital to each of the other modules in the cloud computing unit (108). The analysis module (124) draws its input from the data storage and delivers its analyses to the storage device (122). The analysis module (124), according to one embodiment of the invention, is heuristic in nature. Alternatively, analysis module (124) may be AI-generated or maybe some combination of heuristic and AI-generated; and further will likely evolve as the volume of data increases. Similarly, the action module (126) may also be heuristic in nature. Alternatively, the action module (126) may be AI-generated or may be human-generated, though automated actions will be far more likely to be available in real-time, and thus more useful.

As mentioned hereinabove, the action module (126) processes an analysis of the analysis module (124) to provide actionable recommendation to the user (134) via the subscription module (128). Thus, the subscription module (128) can also be referred to as a publish module since the information is published to the user (134). The publish-subscribe module is the central mechanism connecting users (134) like farmers to the recommended actions. When users (134) are set up in the invented system (100), they become subscribers to recommended actions and other timely information needed to optimize the production of seaweed-derived products or any other organic, water-grown species (132). Subscribers can receive action recommendations in the form of automated telephone calls or text messages or email messages (but not limited to such forms) to ensure timely delivery. Subscribers may receive information tailored to their operational role (e.g., farmers, managers, executives) with varying details suited to decision-making needs. The system also integrates external data such as weather reports to enhance predictive accuracy and actionable insights.

In one exemplary embodiment, the subscription module (128) in the cloud computing unit (108) can link to weather reports of storms that can destroy rafts, monolines and other cultivation mechanisms in advance of their arrival at the farms. The analysis module (124) is configured to utilize those reports to determine if the conditions warrant bringing the rafts to shore to prevent damage. The action module (126) is configured to create messages to the farmers to urgently bring all the rafts in to preserve the seaweed and prevent product loss. Finally, the subscription module (128) is configured to message the farmers rapidly to let them know of the possibility and then actuality of the incoming event and help them protect products and shipments.

In another application of the invented system (100), the data collected from the sensors (110-1, 110-2, . . . 110-n) can be implemented in a synergistic and sustainable aquacultural farming system where the data is analyzed with the analysis module (124). In one example of the farming system, aquatic fish are grown within nets underneath in the floating rafts, and sugar kelps are put around the raft. The waste from the fish acts as nutrients for sugar kelps, and the kelps create oxygen for the fish, and thus create a closed sustainable cycle working toward improving fish and seaweed aquaculture. Using the analysis output from the analysis module (124), the action module (126) can be configured to provide actionable recommendations to set up the aquacultural farming system in a more efficient manner.

The present invention also discloses a method for sensing and monitoring the marine environment. In the invented method, first the plurality of sensors (110-1, 110-2, . . . 110-n) in the buoy (102) detect and obtain predetermined sea parameters tailored to the needs of the species (132) being grown. Then the multiplexer (112), being coupled with said sensors (110-1, 110-2, . . . 110-n), receives the data sensed by each of said sensors (110-1, 110-2 . . . 110-n) to obtain a sensor profile. Next, the processor unit (114) controls said multiplexer (112) and thereby formulates a single data transmission packet from corresponding sensor profile. Next, the data transmission packet undergoes a local encryption by means of an encryption module (116-1) embedded in said processor unit (114). The encrypted data transmission packet is then sent via the radio-communication link.

One embodiment of the present invention is directed towards improved efficiency in power consumption in working of the invented system and method for sensing and monitoring the marine environment. In said embodiment, the sensors (110-1, 110-2 . . . 110-n) can be configured and managed from a remote location to optimize power consumption. Furthermore, based on the requirement of the field of deployment, one or more particular sensors may be swapped out either in the field or at the factory. This modular architecture in terms of removing or exchanging one type of sensor with another type allows the user to repurpose the application of a particular buoy (102) where said sensors (110-1, 110-2, . . . 110-n) are installed. For example, a particular buoy can be configured to act as a discovery buoy that are implemented to measure the specific parameters to decide where to start the aquatic farming process. Further, by exchanging the sensors (110-1, 110-2, . . . 110-n) in the discovery buoy, the user may repurpose the buoy to act a growth buoy that are implemented to measure the specific parameters for better and sustainable production of the aquatic farming. For example, in a discovery buoy, specific parameters may include the amount of nitrate, nitrites, phosphate in the water in relation to the timings of the year, the month or day. This requires a different collection of sensors than those that are required for a growth buoy.

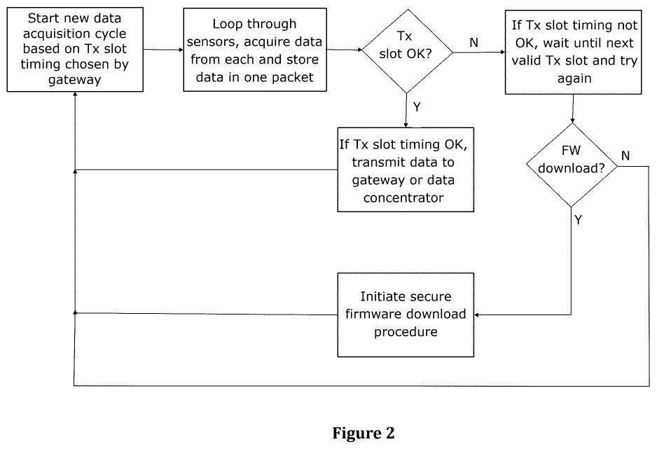

FIG. 2 of the accompanying drawings illustrates a flow chart diagram with the steps related to data acquisition through the sensors (110-1, 110-2, . . . 110-n) in the buoy (102) and the transmission thereof via the gateway (104). The process of data acquisition and its transmission is a continuous and cyclic or closed loop process. As shown in the figure, a fresh data acquisition cycle is initiated based on the transmission slot (Tx slot) timing of the radio-communication link chosen by said gateway (104). Next this process is looped through all of the plurality of sensors (110-1, 110-2, . . . 110-n) to acquire data from each of the sensors (110-1, 110-2, . . . 110-n) and store the same in a single data transmission packet.

Then the status of the Tx slot is checked. In case the Tx slot timing is OK, the data transmission packet is communicated to gateway (104) or data concentrator (106); and thereupon a new data acquisition cycle is initiated. In the case where the Tx slot timing is not OK, the processor unit waits until a next valid Tx slot timing is found. Once valid Tx slot timing is found, the processor unit decides whether to download Firmware (FW) for the buoy (102) or to send the data already stored for transmission. In case it is required to download the FW, a secure FW downloading procedure is initiated, followed by an upload of previously stored data. In case it is not required to download the FW, a new data acquisition cycle is initiated per the gateway-assigned communication protocol for later transmission to the gateway.

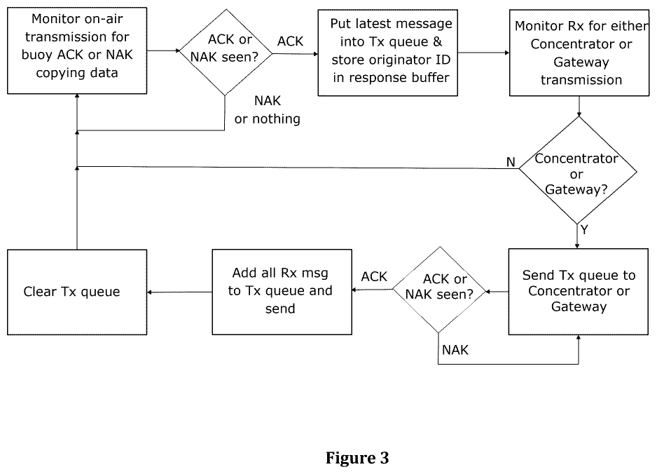

The next section of the invented method takes place in the gateway (104) which sets up communication links with the buoy (102). In scenarios where on-water buoys (102) may not be within communications range of any gateway (104), data concentrators (106) perform the function of a pseudo-gateway. FIG. 3 of the accompanying drawings illustrates a flow chart diagram with the steps related to transmission process of the data transmission packet through a data concentrator (106) or gateway (104). This transmission process too is a cyclic or closed loop process.

In this process, the gateway monitors on-air transmissions from a buoy (102) for a valid transmission (one where the Cyclic Redundancy Checking (CRC) succeeds). If valid data is received, the gateway responds with an ACK, and if not, with a NAK. If a buoy receives an ACK, the cycle proceeds normally. If the buoy receives a NAK, it may optionally re-try the transmission, or drop the packet and try again at the next valid Tx slot.

At the gateway, after it has sent a transmission to the buoy, in the case where no ACK or a valid NAK is received, the latest transmit message is put into the Tx retry queue and the message is sent again at the next Tx slot for that buoy. Next, the receive slot (Rx slot) of the communication link for that buoy is monitored for a retry transmission. If no retry transmissions arrive within the slot time, the retry queue is cleared; if a retry message arrives, it is treated as a normal message from the buoy. At this point, the gateway resumes listening for buoy (102) or data concentrator (106) transmissions in the normal way (at the appropriate Rx slot times for either kinds of messages). Furthermore, each gateway acknowledgment (ACK) provides a mechanism for the gateway (104) to include other instructions to that specific buoy (102), such as the gateway's accurate clock time or other commands to that buoy (102).

In case of a data concentrator's (106) first transmission in the join slot, a request for handshake signal is sent to said data concentrator (106). Next, it is checked whether any ACK or NAK is seen. In case where a lack of acknowledgement (NAK) is detected, a further Tx queue signal may optionally be sent to said concentrator until an acknowledgment (ACK) or lack of acknowledgement (NAK) is detected. If only a NAK or no response is returned, the gateway does not complete the joining protocol. After detecting ACK, the gateway initiates the join protocol and admits the data concentrator to the network.

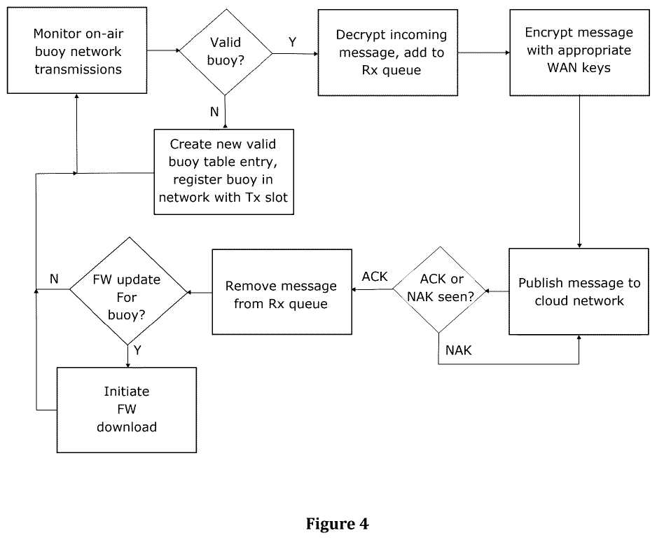

Each gateway (104) first establishes a handshake linkage with the cloud computing unit (108) in the normal wide area network protocol process. The gateway (104) being provided with an encryption module (116-2) establishes a link between the buoy (102) and the cloud computing unit (108) to monitor transmissions and control downloads. With reference to FIG. 4 of the accompanying drawings, the monitoring and controlling actions of an actual gateway (104) is also cyclic in a closed loop. In the process, the on-air transmissions from the communication links of the buoy (102) are monitored. Then the gateway (104) checks whether the buoy (102) is valid within the network or not. In case the buoy (102) is a valid one, a new valid buoy (102) table entry register of said buoy (102) is created in the network using a new Tx slot. Thereupon a new cycle of monitoring on-air transmissions from the new buoy (102) along with all other buoys and data concentrators is initiated. Invalid buoy transmissions are ignored (no response).

In the scenario where the transmission from the buoy (102) is valid and the handshakes succeed, the incoming transmission message is decrypted and added to the WAN Tx queue. Next, the decrypted message may again be encrypted with appropriate wide-area network (WAN) key(s) and subsequently published to the cloud computing unit (108). Once the message has been received by the cloud computing unit (108), the message is removed from the Rx queue. A further checking step is performed to confirm whether there is Firmware (FW) available for the buoy (102). In case an update is available, download handshaking of the buoy (102) FW is followed by the next cycle of monitoring on-air transmissions. Otherwise, the next cycle of monitoring on-air transmissions from the buoy (102) is initiated directly.

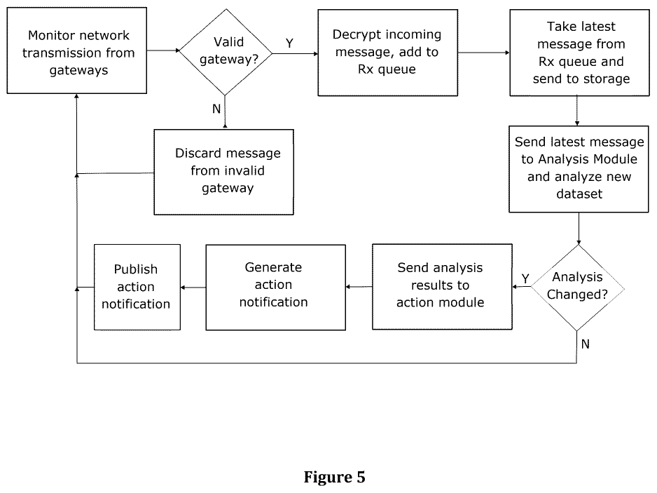

All of the data transmission packets from said gateway (104) are then stored in the cloud computing unit (108) for the analysis and creation of actionable recommendation to the subscribed user (134) by means of various modules (124, 126, 128). With reference to FIG. 5 of the accompanying drawings, the steps involved in the actions taken by the storage device (122) and modules (124, 126, 128) of the cloud computing unit (108) are shown. This too is a closed loop or cyclic process. In the process, the network transmissions from the gateways (104) are monitored. Next it is checked whether the gateway (104) is valid within the network or not. In case the gateway is invalid, the gateway from the data is not taken into consideration, i.e. data transmission received from the gateway is blocked; and a fresh loop of monitoring network transmissions from the valid gateways (104) continues. The gateway (104) needs to be provisioned to participate in any network. That provisioning will be done by personnel, following standard operating procedures to register each gateway's credentials to operate in the cloud computing unit (108).

In case the gateway (104) is valid, after joining, the incoming transmission message is decrypted and added to the Rx queue. Next, the latest message from the Rx queue is extracted and sent to be stored in the storage device (122). Then, the latest message is sent to the analysis module (124) and the latest data transmission packet is analyzed therein. Next it is checked whether the latest analysis has changed with respect to the existing analysis of the analysis module (124). One of the preferred methods is to correlate incoming data against templates derived from existing analyses to indicate a match to something previously found. A lack of correlation with sufficient strength against any of the pre-existing templates indicates a change. If the latest analysis has not changed, then a fresh loop of monitoring network transmissions from valid gateways (104) is continued. However, in case the latest analysis has changed, the analysis result is sent to the action module (126). The action module (126) then generates an actionable recommendation for the users (134) who are subscribed to the cloud computing unit (108) via the subscription module (128). The actionable recommendations are then published and transmitted to the subscribed user (134). Once this process is completed, a new loop of monitoring network transmissions from the gateways (104) is initiated.

One example of implementing actionable recommendations may be found in shrimp fish farms where the conditions for crop loss if trend monitoring is not done are high and have significant economic impact on the farms. If the very rapid growth patterns are not spotted early enough, the entire crop may be a large economic loss. The actionable recommendation from the action module (126) is based on timeliness of continuous monitoring and rapid notification via the subscription module (128) of impending doom. The notification may relate to ammonia content of fixed-volume pond is escalating out of control such as “ADD WATER NOW”. Alternate notification may include “Based on prior data, the rate of growth of ammonia will reach critical levels in three weeks: prepare to harvest the crop and get that into trucks within a week to ensure healthy shrimp arrive at your customer's doorstep, preserving your income.”

An important aspect of this invented system (100) is that although the acquisition of data, its analysis and the recommendations based on this data, are all highly automated, there are always people in the decision loop. Automated systems are very helpful when events that have been understood and analyzed arise, but human judgment is often needed and is critical when something new and unexpected arises, especially for new sites and installations. The human control element helps keep the automated systems from heading down an un-explored, catastrophic path when new situations arise. An important aspect of the system (100) also is its flexibility: as new data flows into the system (100), the analysis module (124) can use the data to help generate better actionable recommendations and better outcomes using continuous improvement methods.

The buoy integrates a GPS tracker into its electronics printed circuit board, used for conditioning analog sensor signals and digitization through a processor unit. The GPS tracker supports multiple satellite systems, including GPS, GLONASS, BeiDou, Galileo, and IRNSS, delivering sub-meter accuracy. The GPS update rate is adjustable via commands issued through the LoRaWAN network. This geolocation capability enables position tracking of the buoy and detection of unauthorized movement or tampering.

In the first exemplary embodiment of the invention, the system (100), is utilized to monitor, analyze and provide actionable recommendations for seaweed aquaculture. More specifically in this embodiment, The system (100) is utilized for a condition which is unfavorable to the production of seaweed.

The complete system (100) for seaweed aquaculture consists of the buoy (102), the data concentrator (106), the gateway (104) and the cloud computing unit (108). As mentioned hereinabove, the data concentrator (106) performs the same basic function as a gateway but is used when the buoys (102) are not within range of a true gateway (104). Consequently, this description hereinbelow will describe just the functionality of the data concentrator (106) as a gateway and will omit a more detailed description of it as has been provided elsewhere. Additionally, the system (100) will be assumed to have been in operation for some time, so this description will omit the descriptions of loading and verifying operational firmware for the buoy (102) and the gateway (104).

The buoy (102) has internally four basic elements: the sensors (110-1, 110-2, . . . 110-n) which will be used to measure the condition of the seawater, electronics that convert the analog sensor data into digital data, electronics that communicate that digital data wirelessly to the gateway (104) and a power source (130) for all of the electronic elements of the buoy (102). The power source (130) for the buoy can be any combination of solar cells, primary or rechargeable batteries, wave-based power converters or any other mechanism capable of providing sufficient DC power to the buoy for the duration of the growth cycle of the seaweed. The sensors (110-1, 110-2, . . . 110-n) consist of several different aquaculture devices that measure properties important to seaweed growth. Examples of such sensors are pH, dissolved oxygen, water temperature (including water temperature at different depths), water conductivity, water turbidity, air temperature, barometric pressure, solar illumination and internal DC power parameters such as battery capacity and battery condition.

The electronics involved in the buoy (102) consist of mechanisms to, either sequentially or in parallel, measure each of the sensor data and make that data available for eventual transmission to the gateway (104). Examples of such mechanisms are multiplexers (112) to deliver sensor data to a single analog-to-digital converter, or multiple-channel analog-to-digital converters, one for each sensor (110-1, 110-2, . . . 110-n) being measured, or any combination thereof. Electronics may also provide electronic mechanisms to store the sensor data locally (perhaps in case of a failure of the communications link) or for the purpose of on-buoy analysis and reduction of the data). In addition, the electronics include mechanisms to convert the digital data to wireless signals that can be transmitted to a gateway (104) that is not attached to the buoy (102). Examples of such mechanisms include but not limited to direct radio signals to a locally available gateway, radio signals sent to a satellite that acts as a long-distance gateway, underwater acoustic signals to an acoustic-electronic gateway or laser signals to an optical-electronic gateway.

As an example, consider a configuration of the buoy that has 8 sensors: pH, dissolved oxygen, conductivity, turbidity, water temperature, air temperature, solar illumination and battery condition. An embodiment of this buoy could have the electronics sequentially connect the eight sensors sequentially to an analog-to-digital converter under control of a processor unit (114). The processor unit (114) then can store each analog sample in variables that represent each type of sensor data acquired. After all the sensors (110-1, 110-2, . . . 110-n) have been sampled, the processor unit (114) can assemble the acquired data values into a time/location-stamped message. At a time consistent with the protocol used by both the buoy (102) and the gateway (104), the processor unit (114) can then direct the communication unit (118) to send the time-stamped data to the gateway (104). The processor unit (114) can then disconnect some or all sensors (110-1, 110-2, . . . 110-n) and put all electronic elements of the buoy (102) into a low-power mode to conserve battery life. At the appropriate time determined by the protocol and the sleeping processor unit, the buoy (102) can be brought back to the condition of preparing to take data and the data acquisition cycle can begin again.

Now the particular example under this embodiment is considered where the data has some potential significance. In this consideration, the seaweed (132) is of a type that is susceptible to an ice-ice condition. In this condition, seaweed dies when the water and air temperature is too high and the solar illumination is too strong, characterized by several days with the water/air temperature exceeding 27° C. and the illumination exceeds 100 W/m2 for more than 2 hours. Also assume that the buoy (102) has no provision for local processing of the data and that the sea conditions have been favorable until this day and that the ice-ice conditions will persist for at least a week. Under these conditions, after several days, the seaweed will show signs of distress and after a week, the seaweed will be dead and useless for harvest.

The buoy (102) will operate normally and will acquire the sea conditions and transmit those data to the gateway (104). The gateway (104) will, in turn, relay that data from the buoy (102) to the storage device (122) in cloud computing unit (108). The primary function of the gateway is to operate the bi-directional protocol that relays data from all the buoys in its field of view to storage device (122) in cloud computing unit (108). The gateway (104) also has a secondary function to provide firmware updates to each of the buoys (102) within its purview, but that does not concern this example now. The data from multiple buoys over several days is uploaded from the gateway (104) to the storage device (122) in cloud computing unit (108) via a subscription module (128) enabled to publish said data as well as actionable recommendations.

As the incoming data from multiple gateways (104) arrives at the cloud computing unit (108), new data is automatically routed from memory device (120) to the cloud analysis module (124). This module is responsible for examining incoming data from each buoy (102) and classifying the data according to heuristic and/or analytic-AI-generated rules which have thresholds for at least “good growth” and “abnormal” conditions. When the incoming data from any particular buoy (102) is flagged as an “abnormal leading to ice-ice” condition, the analysis module (124) keeps track of both the condition, the buoy whose data that generated that abnormal condition and the general location by either the buoy (102), the gateway (104) or the farm and sets flags indicating normal or abnormal conditions along with the amount of time abnormal conditions have been recorded. The analysis module (124) then makes a decision based on the condition, the time duration of the condition, how many buoys report that same condition and other rules, whether to flag the action module (126) with a recommendation or not.

This data indicating the onset of an ice-ice condition triggers the analysis module (124) to set flags to examine if the trend of temperature has been rising for that buoy over the last several days, and if so, then to indicate to the action module (126) that this buoy (102) has seen the onset of an ice-ice condition. At this point, if only one buoy (102) has transmitted data that has passed the ice-ice threshold, the analysis module (124) may choose to wait for confirmation of further excursion of the temperature and solar irradiance from multiple buoys. However, if the condition represents an extremely fast onset (for example, a rise of 3 degrees in one day coupled with particularly strong solar illumination), the analysis module (124) may indicate the rapid onset of potential ice-ice conditions that merit quick action. It may also optionally flag the affected gateways to revise the reporting time for the buoys reporting this condition to be more often, to validate the condition. Additionally, depending on the threat conditions, the sampling rate of the sensors (110-1, 110-2 . . . 110-n), either selectively or collectively, may be adjusted.

If the latter condition is indicated, the analysis module (124) sends a message with the appropriate parameters to the action module (126) indicating the condition merits immediate attention. The action module (126) then uses heuristics and/or generative AI formulations to create a message indicating that ice-ice conditions are arising and to bring the affected rafts in to shore immediately. This is because leaving those rafts out in ice-ice conditions can cause the entire inventory to be wasted, and processing the existing seaweed (132) at the onset of ice-ice both preserves some inventory and ensures viable seeds are preserved as well. The messages indicated are then transmitted to the subscribers (company operational teams, managers and farmers) over normal wired and wireless links to direct the teams to take the recommended actions.

In fact, the actions can have criticality indices as well as recommendations to help the various farm workers to decide how quickly to address the issue. In a preferred embodiment of the invention, various subscribers might receive differing messages based upon their roles. For example, farmers may have simplified messages (for example, in the case of the initial onset of ice-ice, simple indications that ice-ice conditions have arisen). Managers might have more complex messages indicating exactly how many buoys (102) are reporting ice-ice conditions (larger numbers may mean more farms are impacted). Company executives may receive more complex messages yet indicating the state of ice-ice compared to the sales orders and which customers are impacted and estimates of potential impact.

To follow this example further, it is easy to see that if the cloud computing unit (108) also subscribes to local weather conditions and forecasts, that the analysis module (124) may use external data to provide additional information to the action module (126), and that in turn may provide more nuanced recommendations from the action module (126). If the reported conditions are merely a very short anomaly, due to a storm arising that will soon arrive, dropping temperatures and occluding the sun, the analysis module (124) can provide more nuanced information to the action module (126) indicating that additional information, say from weather services, suggest that the onset of ice-ice conditions may be temporary and to take no immediate action. As more and more data accumulate in the cloud computing unit (108), the analysis module (124) will become more accurate, and the action module (126) will have better recommendations for the various people involved in that particular aquaculture.

The buoy (102) is the source of all data collected for the system (100). It is anticipated that the buoy (102) will attract the attention of other aquaculture farmers that compete in the same geographic area, and will by its usefulness, have some value to competitors. For that reason, the buoy (102) includes the ability to provide geolocation data to the modules (124, 126, 128) in the cloud computing unit (108), both static location data and movement data. This will be important if some competitors for seaweed aquaculture or fish aquaculture take the buoy to either disadvantage the owner of the buoy (102) or to take it apart to copy it. In addition to the location capability, the buoy (102) also implements tamper detection and, optionally, internal firmware wipe or physical destruction on tamper detection. The tamper detection and destruction mechanisms can be activated autonomously or via the gateway (104) upon detection.

In a second exemplary embodiment of the invented system, as described hereinbelow and referred to as system (100), is utilized to capture of fine-grained sea conditions.

Now the particular example under this embodiment is considered where the data has some potential significance. In this consideration, the issue addressed is the one where the weather data that weather organizations have and can access are not particularly fine-grained around the surface of the Earth and, in terms of sea conditions, are generally localized where weather buoys are available (if they are available at all). Also, weather organizations can utilize satellite data, but those data only represent a few centimeters below the surface of the sea. Very little extensive fine-grain data exists concerning the conditions 1 or more meters below the surface of the sea. Also missing are data about sea current velocities and direction, temperature, salinity, turbidity, and pH below the surface.

As part of the work needed to grow seaweed in near-coastal locations, seaweed aquaculture needs very similar data. The buoy (102) is designed to gather most of the data that weather organizations need. As aquaculture farms, both seaweed and fish, proliferate around coasts around the Earth, local and global weather companies have expressed serious interest in the data gathered for the aquaculture to aid in both reporting weather conditions and to improve the forecast of local weather conditions. The system (100) is well-adapted to provide that data as the distribution of near-shore and deep-water farms begin to expand around the globe. In essence the steps to obtain the data are the same as for aquaculture up to the point where the buoy data is stored in the cloud computing unit (108). As the datasets become available, it is trivial for the weather organizations to become subscribers to the data (assuming the economics are justifiable) in real time. They could also utilize customized analysis modules (124) and action modules (126) for their own purposes.

As already mentioned, the foregoing description is illustrative of the invention and not limitative to its scope, because it will be apparent to persons skilled in the art to devise other alternative embodiments without departing from the broad description of the disclosures made herein.

Part-List:

| Description | Sr. No. |
|---|---|
| System | 100 |
| Buoy | 102 |
| Gateway | 104 |
| Data concentrator | 106 |
| Cloud computing unit | 108 |
| Sensors | 110-1, 110-2, . . . 110-n |
| Multiplexer | 112 |
| Processor unit | 114 |
| Encryption module | 116-1, 116-2 |
| Communication unit | 118 |
| Memory devices | 120 |
| Storage device | 122 |
| Analysis module | 124 |
| Action module | 126 |
| Subscription module | 128 |
| Power source | 130 |
| Aqua life/species | 132 |
| User | 134 |

We claim:

1. A system (100) for sensing and monitoring a marine environment, the system (100) comprising:
at least one buoy (102), each buoy (102) comprising:
a plurality of sensors (110-1, . . . 110-n) configured to detect one or more marine environment parameters,
a processing unit (114) configured to:
receive sensor data from the plurality of sensors (110-1, . . . 110-n);
assemble the received sensor data into a sensor profile; and
form a single data transmission packet from the sensor profile,
at least one gateway (104) configured to receive the data transmission packet from the at least one buoy (102), and
a cloud computing unit (108) comprising:
a storage device (122) configured to store the data transmission packets transmitted by the at least one gateway (104),
an analysis module (124) configured to analyse stored data transmission packets to identify conditions of interest,
an action module (124) configured to generate actionable recommendations based on outputs of the analysis module (124), and
a subscription module (128) configured to publish the actionable recommendations to one or more subscribers/users.

2. The system (100) as claimed in claim 1, wherein the system (100) further comprises at least one data concentrator (106) configured to act as a store-and-forward node for receiving and forwarding the data transmission packets from one or more buoy (102) to the at least one gateway (104).

3. The system (100) as claimed in claim 1, wherein the at least one buoy (102) further comprises:
an encryption module (116-1) configured to encrypt the data transmission packet,
a communication unit (118) operable to transmit the encrypted data transmission packet to the gateway (104) via a communications link, and
a power source (130) configured to supply power to the buoy (102).

4. The system (100) as claimed in claim 1, wherein the gateway (104) is configured to: receive the encrypted data transmission packet from the at least one buoy (102) via the communication link,
the gateway (104) further comprising an encryption module (116-2) configured to: decrypt and, when required, re-encrypt the data transmission packet for transmission to the cloud computing unit (108).

5. The system (100) as claimed in claim 3, wherein the gateway (104) is configured to: receive the encrypted data transmission packet from the at least one buoy (102) via the communication link,
the gateway (104) further comprising an encryption module (116-2) configured to: decrypt and, when required, re-encrypt the data transmission packet for transmission to the cloud computing unit (108).

6. The system (100) as claimed in claim 1, wherein the plurality of sensors (110-1, . . . 110-n) comprise one or more sensors selected from the group comprising: pH sensors, dissolved oxygen sensors, water temperature sensors, water conductivity sensors, turbidity sensors, solar illumination sensors, underwater flow velocity sensors, underwater flow direction sensors, barometric pressure sensors, surface airflow velocity sensors, solar illumination sensor, surface airflow direction sensors, wave action sensors, and chemical pollutant sensors for detecting nitrates, nitrites, phosphates, and ammonia.

7. The system (100) as claimed in claim 1, wherein the processing unit (114) comprises:
an analog-to-digital subsystem having multiple channels, and
a memory configured to store sensor readings until a complete sensor profile is obtained,
wherein the processing unit (114) is further configured to: adjust power state of electronic elements of the at least one buoy (102) to a low-power mode between sampling cycles; and selectively wake-up elements according to a transmission schedule assigned by the gateway (104).

8. The system (100) as claimed in claim 3, wherein the encryption module (116-1) of the at least one buoy (102) is configured to:
perform a cryptographic handshake with the gateway (104), and
locally encrypt the data transmission packet at least once prior to transmission,
wherein the encryption module (116-2) of the at least one gateway (104) is configured to maintain a buoy-specific bidirectional cryptographically encrypted communications link with each buoy (102), using a unique cryptographic key or unique credentials of each buoy (102) allowing a subscriber-level access control.

9. The system (100) as claimed in claim 4, wherein the encryption module (116-1) of the at least one buoy (102) is configured to:
perform a cryptographic handshake with the gateway (104), and
locally encrypt the data transmission packet at least once prior to transmission,
wherein the encryption module (116-2) of the at least one gateway (104) is configured to maintain a buoy-specific bidirectional cryptographically encrypted communications link with each buoy (102), using a unique cryptographic key or unique credentials of each buoy (102) allowing a subscriber-level access control.

10. The system (100) as claimed in claim 2, wherein the data concentrator (106) is a node without local sensors, and comprises: at least one memory device (120) configured to store data transmission packets from multiple buoys (102); and further configured to forward stored packets to the at least one gateway (104) using a multi-hop mesh network topology.

11. The system (100) as claimed in claim 1, further comprising:
a tamper-detection mechanism disposed within the buoy (102) configured to:
upon detection of tampering, cause the buoy (102) to erase stored data and operating firmware. or
when enabled and available, to initiate a self-destruction protocol,
wherein the gateway (104) or the data concentrator (106) is configured to direct the tampered buoy (102) to perform the erasure or self-destruction of stored data and operating firmware, upon receiving a tamper notification.

12. The system (100) as claimed in claim 3, wherein the power source (130) comprises: one or more of solar cells, and/or power harvester, and/or a rechargeable or primary battery, and an energy management module configured to measure state-of-charge of the power source (130) and to manage sensor sampling and transmission schedules to conserve energy.

13. The system (100) as claimed in claim 1, further comprising:
a GPS tracker configured to provide a geolocation data of the at least one buoy (102) to the cloud computing unit (108); and
a buoyancy control mechanism configured to alter a vertical position of the buoy (102) relative to a sea surface to achieve a target seaweed growth condition based on sensor data.

14. The system (100) as claimed in claim 1, wherein
the analysis module (124) of the cloud computing unit (108) is configured to detect an onset of an adverse condition for aqua life (132) to be farmed, based on thresholds and time trends,
the action module (126) is configured to generate an actionable recommendation, and
the subscription module (128) is configured to publish the actionable recommendation; and deliver recommendations to at least one user/subscriber device, as automated telephone calls, text messages, or electronic mail, and vary the content of the message according to subscriber role.

15. The system (100) as claimed in claim 1, wherein the at least one buoy (102) further comprises a removable sensor interface providing modular exchangeability of one or more sensors (110-1, . . . 110-n) so that the buoy (102) can be reconfigured in the field based on its application.

16. The system (100) as claimed in claim 15, wherein the application of said buoy (102) comprises discovery of chemical pollutants, growth condition detection, and climate data collection in the marine environment.

17. A method for sensing and monitoring a marine environment, comprising the steps of:
detecting one or more marine environment parameters by means of a plurality of sensors (110-1, . . . 110-n) disposed on at least one buoy (102);
receiving, sensor data from the plurality of sensors (110-1, . . . 110-n), and assembling, by a processing unit (114), the received sensor data into a sensor profile;
forming a single data transmission packet comprising the sensor profile and time/location metadata by the processing unit (114);
transmitting the data transmission packet from the at least one buoy (102) to at least one gateway (104) via a communication link;
forwarding the data transmission packet from the at least one gateway (104) to a cloud computing unit (108);
storing the data transmission packet in a storage device (122) of the cloud computing unit (108);
analyzing the stored data transmission packet(s) to identify a condition of interest by an analysis module (124) of the cloud computing unit (108); and
generating, by an action module (124) of the cloud computing unit (108), an actionable recommendation based on the identified conditions of interest and thereupon publishing the actionable recommendation to one or more subscribers/users via a subscription module (128) of the cloud computing unit (108).

18. The method as claimed in claim 17, further comprising the intermediate steps of:
locally encrypting the data transmission packet at least once before transmission, by an encryption module (116-1) of the at least one buoy (102), and
receiving, by the at least one gateway (104), the encrypted data transmission packet and decrypting the encrypted data transmission packet by an encryption module (116-2) of the gateway (108).

19. The method as claimed in claim 17, wherein detecting one or more marine environment parameters comprises: sensing one or more of pH, dissolved oxygen, water temperature, water conductivity, turbidity, solar illumination, underwater flow velocity, underwater flow direction, barometric pressure, surface airflow velocity, solar illumination, surface airflow direction, wave action, and chemical pollutant for detecting nitrates, nitrites, phosphates, and ammonia or other pollutants.

20. The method as claimed in claim 17, further comprising: adjusting power state of electronic elements of the at least one buoy (102) into a low-power mode between sampling cycles; and selectively wake-up elements according to a transmission schedule assigned by the gateway (104).

21. The method as claimed in claim 17, further comprising: performing a handshake, by the at least one gateway (104), with the data concentrator (106) joining a network; returning an acknowledgement (ACK) if a received packet has valid network credentials, cyclic redundancy check (CRC) and returning a non-acknowledgement (NAK) otherwise, and wherein packets at the data concentrator (106) receiving a NAK are placed in a retry queue of the data concentrator (106) for re-transmission at a next valid joining transmission slot.

22. The method as claimed in claim 17, further comprising applying heuristic rules or AI-based classification to incoming data by means of the cloud computing unit (108), to distinguish between normal conditions and abnormal conditions for aqua life (132), and setting flags and trend indicators used to determine whether to escalate an actionable recommendation.

23. The method as claimed in claim 17, further comprising adjusting sampling rates of one or more sensors (110-1, . . . 110-n) responsive to detect an abnormal condition, to increase a frequency of sampling and reporting.

24. The method as claimed in claim 17, further comprising detecting: an onset of an ice-ice condition based on a combination of seawater temperature and solar illumination trending beyond predefined thresholds and/or matching internally defined conditions, and in response to detecting the onset of the ice-ice condition, causing via the action module (124) one or more of: (i) an instruction to a buoyancy control mechanism to alter vertical position of the at least one buoy to a subsurface level having lower temperature and illumination, and (ii) generating a recommendation to operators to bring the at least one buoy to shore.

25. The method as claimed in claim 17, further comprising: securely distributing and installing operational firmware to one or more buoys (102) following a handshake mechanism validating network credential(s) of the buoy(s) (102) prior to permitting the firmware download.

26. The method as claimed in claim 17, further comprising: detecting a tamper event at the at least one buoy (102); and transmitting, from a data concentrator (106) or gateway (104), an instruction to the at least one tampered buoy (102) to erase stored data and operating firmware and/or destroy buoy internals.

27. The method as claimed in claim 17, further comprising: detecting incursions of fish or other seaweed predators near a farm using hydrophones or other acoustic or chemical sensors; and in response to the detected incursions, selectively releasing into the surrounding water a processed liquid derived from an alternate seaweed that deters fish or activating an acoustic deterrent field to discourage fish or other seaweed predators feeding on the growing seaweed.

28. The method as claimed in claim 17, further comprising: customizing published recommendations according to a subscriber role by means of the cloud computing unit (108) by generating simplified messages for field operators and progressively more detailed messages for managers and executives, including criticality indices, timelines and estimated impacts.

29. The method as claimed in claim 17, further comprising using the storage device (122) to retain multi-day time-series data from multiple buoys in a farm, and using trends across multiple buoys and multiple farms to refine heuristic thresholds and AI models used by the analysis module (124).

30. The method as claimed in claim 17, further comprising operating the data concentrator (106) as a mesh network node that receives one or more packets from a plurality of buoys (102), storing the one or more packets locally when a direct gateway (104) link is unavailable, and forwarding the stored packets when a path to a gateway (104) linked to the cloud computing unit (108) becomes available.

31. The method as claimed in claim 17, further comprising correlating local buoy-sensed data with external weather forecast data and using the correlated forecasts to refine actionable recommendations generated by the action module (124).
